(19) United States
(12) Patent Application Publication
(10) Pub. No.: US 2006/0152491 A1
(43) Pub. Date: Jul. 13, 2006

(54) Mouse and remote control integration control method and device

(75) Inventor: Hui-Pin Lian, Changhua City (TW)

Correspondence Address: TROXELL LAW OFFICE PLLC, SUITE 1404, 5205 LEESBURG PIKE, FALLS CHURCH, VA, 22041, US

(73) Assignee: Yankee Technology Co., Ltd.

(21) Appl. No.: 11/030,942

(22) Filed: Jan. 10, 2005

(51) Int. Cl. G09G 5/08

(52) U.S. Cl. 345/166

(57) ABSTRACT

A mouse and remote control integration control method and device in which the surface of an optical ball is the sensing point for optical sensors, with a ballast block uniquely disposed in the optical ball as the center of gravity that causes it to face downward such that as the body of the present invention is turned along the X- and Y-axis, the optical ball does not move because of a suspending means, enabling the optical sensors to sense the surface of the optical ball. The suspending means consists of placing the optical ball in a liquid such that suspension is based on buoyancy or over a plurality of roller balls in the optical ball recess which support and suspend the optical ball to thereby enable cursor displacement by the mouse controller. The body in which the optical ball is situated can be a remote control unit, a mouse, or a cordless keyboard, enabling infrared or radio signal transmission on a television or display such that various electronic equipment can be remotely controlled or enabling signal transmission to a personal computer via a wireless receiver serving as a computer connection, utilizing the display to provide for the remote control of computer networking or operation and thereby achieving midair operation of the remote control unit of the present invention without relying on any flat surface for operating functions. Furthermore, a switch toggles the optical sensor sensing direction, enabling the remote control unit of the invention herein to provide for various integrated function mouse applications.

### BACKGROUND OF THE INVENTION

1) Field of the Invention

The invention herein relates to a mouse and remote control integration control method and device in which an optical ball is situated in the recess of the remote control unit and supported by a suspension means, with a ballast block disposed in the optical ball that defines the center of gravity of the optical ball and causes it to face downward. Optical sensors are utilized to sense the surface of the optical ball such that the mouse, keyboard, and remote control unit in which it is situated is turned in midair to control the sensing of the optical ball surface by the optical sensors that articulate cursor displacement on a television screen or display. As such, the present invention provides for the near and remote control of computer networking or operation, and even control over the operation of various electronic, equipment.

2) Description of the Prior Art

A conventional mouse utilizes optical sensors that are positioned at the lower extent of the mouse, as indicated in FIG. 1-A, and the said mouse must be moved on a X- and Y-axis plane to control cursor displacement (as shown in FIG. 1-B).

The keyboard utilized is miniaturized and then integrated with a remote control unit into a single structural entity for keyboard operation between a television screen and a computer.

### SUMMARY OF THE INVENTION

I. Problems to be Solved

1. The said conventional mouse is incapable of midair cursor control and limited to use on a planar surface and thus its operation subject to limitations.

2. A miniaturized keyboard integrated with an electronic equipment remote control unit only provides for single-function switching and an additional cordless mouse must be utilized and, as such, operation lacks convenience.

3. Since the said mouse typically has to be utilized on a planar surface to enable optical sensor cursor control and cannot be utilized in midair, it is subject to further overall limitations.

2. Problem Solutions

1. The invention herein utilizes an optical ball having a ballast block disposed in it, the ballast block defining the center of gravity and causing a downward facing state, and situated in the recess of remote control unit, the said recess filled with a liquid or a plurality of roller balls that serve as suspending means which support the optical ball and, furthermore, an upward facing optical sensor is disposed at the exact lower extent of the recess, the said optical sensor sensing the optical ball surface for coordinates displacement, the signal of a mouse controller are sent to a transmitter transmit module and then transferred to the receive module of a receiver, the receive module reads data from a microprocessor controller and a command control signal is outputted via a universal serial bus (USB), thereby providing for the computer control required for remote equipment operation.

2. The said remote control unit has an optical sensor switch that toggles between an upward facing optical sensor as well as a downward facing optical sensor that are capable of planar surface sensing, thereby providing for general mouse applications.

3. The remote control unit has a built-in keyboard, the keyboard controller of which outputs signals via a keyboard signal transmitter to a receive module and then a receiver controller transfers the signals to the computer, thereby providing for direct operation on a television display as well as providing for general cordless keyboard applications such as wireless networking and other operations.

4. The said remote control unit signals, issued by command, are forwarded to an infrared microprocessor and then to an infrared signal transmitter for the direct control of various electronic products (such as amplifiers and air conditioners, etc.).

III. Capability of the Invention

1. The said remote control unit can be utilized in midair as a mouse for directly controlling cursor displacement on a television or display.

2. Mouse utilization is switchable between normal flat surface and cordless modes.

3. The said remote control unit has built-in keyboard function switches that are capable of wireless or direct operation on televisions or displays.

4. The said remote control unit has an infrared microprocessor that stores various brands of codes and its infrared signal transmitter is capable of automatically scanning the remote control frequencies of equipment for the direct control and operation of various electronic products.

5. The invention herein integrates a cordless mouse, a cordless keyboard, and an infrared remote control into a single structural entity, thereby providing for enjoyable control and a range of different applications.

### BRIEF DESCRIPTION OF THE DRAWINGS

FIG. 1-A is an orthographic drawing of the prior art mouse, as viewed from a lateral perspective.

FIG. 1-B is an isometric drawing of the prior art mouse that illustrates its operation.

FIG. 2-A is an isometric drawing of the integrated mouse, keyboard, and infrared remote controller of the invention herein.

FIG. 2-B is an isometric drawing of FIG. 2-A, as viewed from the rear.

FIG. 2-C is an isometric drawing of the invention herein in the battery charging state.

FIG. 3-A is an orthographic drawing of the optical ball static state of the invention herein.

FIG. 3-B is an orthographic drawing of the optical ball dynamic state of the invention herein.

FIG. 4-A is an orthographic drawing of another optical ball static state embodiment of the invention herein.

FIG. 4-B is an orthographic drawing of another optical ball dynamic state embodiment of the invention herein.

FIG. 5 is a control system diagram of the invention herein.

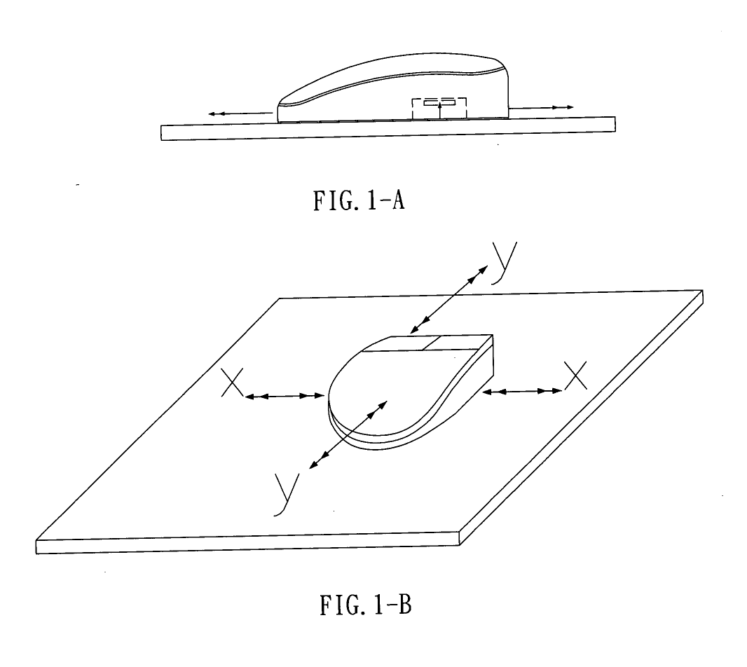

### DETAILED DESCRIPTION OF THE PREFERRED EMBODIMENTS

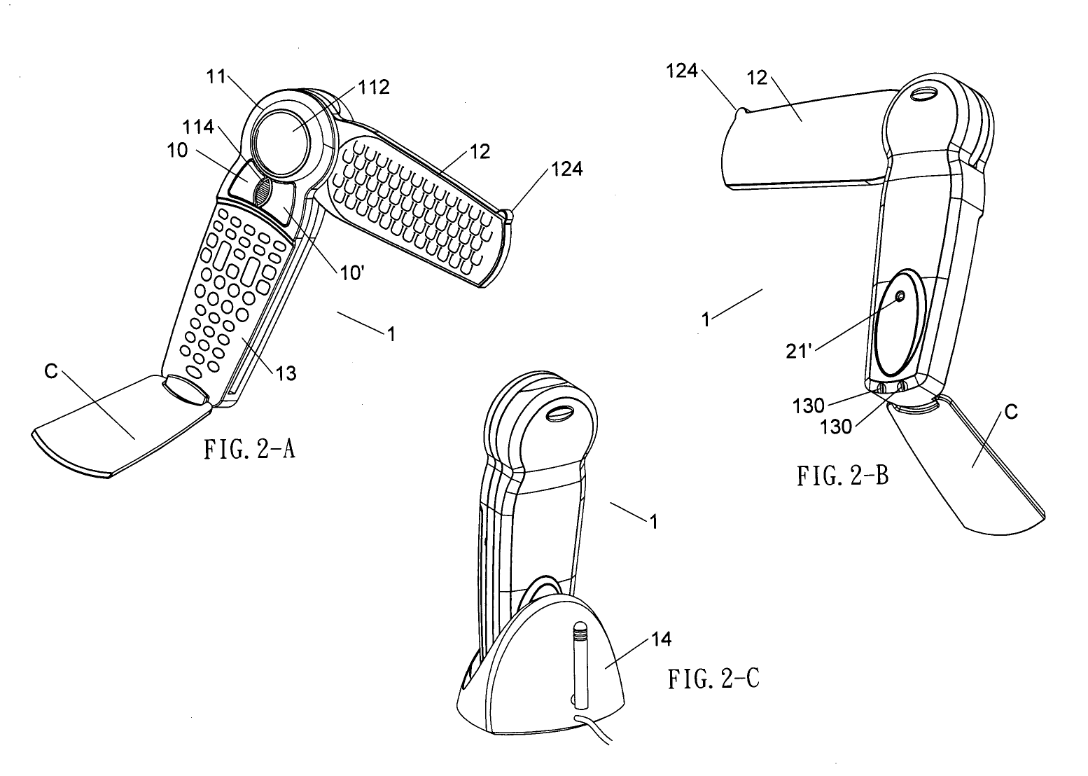

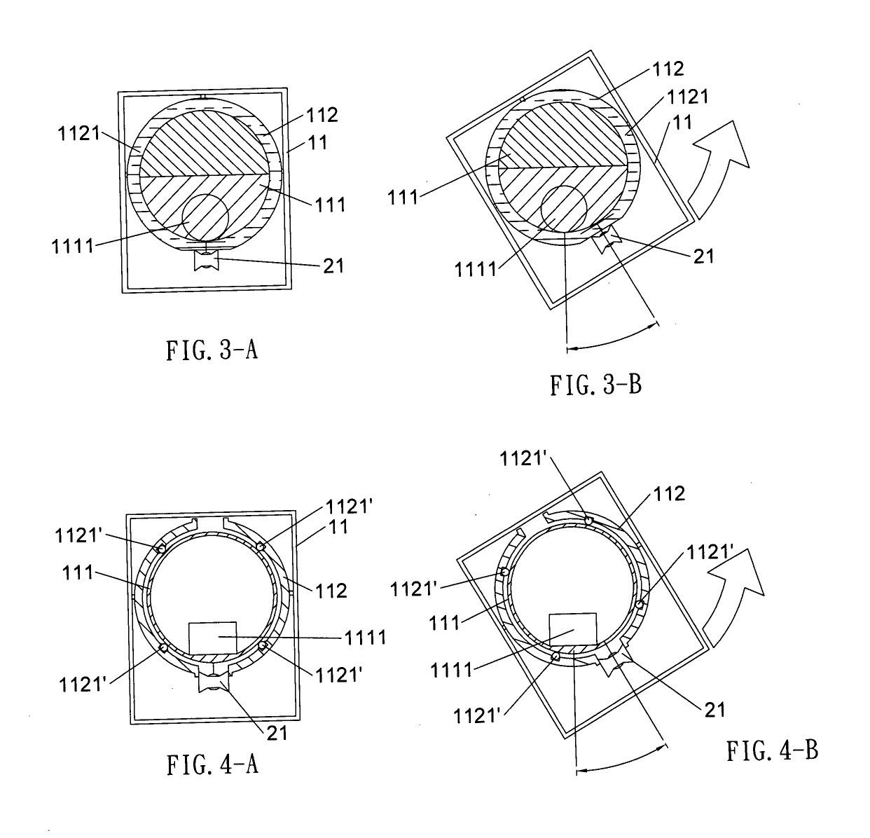

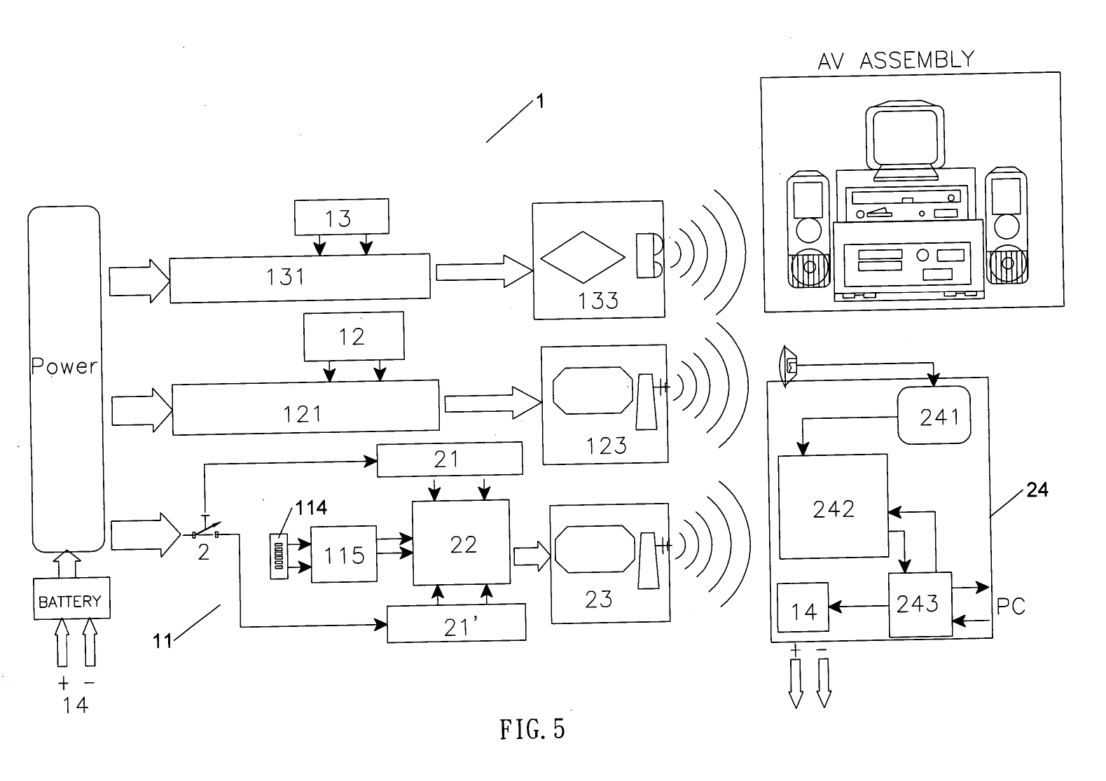

Referring to FIG. 2-A, FIG. 2-B, and FIG. 2-C, the said remote control unit 1 consists of a mouse 11, a cordless keyboard 12, and an infrared remote controller 13 integrated into a single structural entity; referring to FIG. 3-A and FIG. 3-B, the optical ball 111 of the said mouse 11 has an internally disposed ballast block 1111 and is situated within the recess 112 of the said mouse 11, the said recess 112 can be filled with a liquid 1121 or a plurality of roller balls 1121′ (as shown in FIG. 4-A and FIG. 4-B), enabling the optical ball 111, with the ballast block 1111 at its center of gravity, to float in the recess 112 or enabling the optical ball 111, with the ballast block 1111 at its center of gravity, to face downward perpendicularly by means of roller balls 1121′ that limit its position; an upward facing optical sensor 21 is correspondingly disposed at the exact lower extent of the said ballast block 1111 and a downward facing optical sensor 21′ is disposed at an appropriate position on the back surface of the remote control unit 1, with a switch 2 providing for toggling between the upward facing or downward facing sensing states (FIG. 5).

Referring to FIG. 3-B and FIG. 5, when the sensor switch 2 is toggled to the upward facing optical sensor 21 and the surface of the optical ball 111 is sensed, the upward facing optical sensor 21 fetches data from the said signal from the mouse controller 22, the cursor displacement operation or coordinates signal error are respectively corrected or ignored, the control signals are outputted through the mouse signal transmitter 23, the signals are forwarded to the remote receiver 24, the receive module 241 of which fetches the signal from the receive controller 242, at the same time, after the microprocessor 243 reads the data, the signals are transferred to a personal computer (PC) via a universal serial bus (USB) port 243, enabling the indication of the cursor position on a television or display, at the same time, as mouse 11 midair X- and Y-axis turning occurs, the optical ball 111 having the ballast block 1111 at its center of gravity is maintained in a perpendicular downward facing state and does not move, enabling the upward facing optical sensor 21 oriented towards the optical ball 111 surface to sense the X- and Y-axis, and the said signal is then transferred to the mouse controller 22, the upward facing optical sensor 21 data is read, and the mouse controller 22 executes a cursor displacement correction operation in which the coordinates data is corrected and error data is ignored; the control signal is then outputted through the mouse signal transmitter 23, the said control signal is then acquired by the receiver 24 receive module 241, the receive controller 242 then reads the receive module 241 data, and the control signal is transferred to the PC via the USB port 243 to control display screen scrolling, enabling the said mouse 11 to provide for the midair control of cursor movement as well as various operating conveniences and enjoyment; when the sensor switch 2 is closed and thereby toggled to downward facing optical sensor 21′ transfer, this enables the mouse 11 to provide for direct planar sensing when situated on a flat surface, its signal sent to the mouse controller 22 with the data at the same time fetched by the downward facing optical sensor 21′, the control signal is forwarded to the mouse transmitter 23 and the signal then transferred to the distant wireless receiver 24 for general mouse applications.

Referring to FIG. 2-A, FIG. 2-B, and FIG. 5, the said keyboard 12 is disposed on the mouse 11 case, the keyboard 12 inputs the said command signals, through the keyboard controller 121 which at the same time reads the data inputted by the keyboard 12, the keyboard signal transmitter 123 then outputs control signals, enabling the said same receiver 24 to execute PC output of the control signals, providing for network and operating system operations.

The said infrared remote controller 13 is disposed at an appropriate location on the mouse 11 case and, furthermore, the corresponding codes of various electronic product can be stored beforehand in the said infrared microprocessor 131, enabling the user to first input the corresponding desired remote control corresponding code, such that the infrared microprocessor 131 reads the internally stored data, the infrared signal transmitter 132 then automatically or manually scanning for the corresponding remote control frequency to provide for the direct control of various infrared electronic equipment.

Referring to FIG. 2-A, FIG. 2-B, and FIG. 2-C, the said remote control unit 1 is conjoined to the mouse 11, the cordless keyboard 12, and the infrared remote controller 13 as a single structural entity, the main feature of the invention herein is that the remote control unit 1 is capable of providing for midair control of cursor displacement but also convenient operation by providing for various practical functions such as mouse 11 left and right keys 10 and 10′, a center key scrolling device 114, the optical ball 111 positioned at the recess 112 (as shown in FIG. 3-A, FIG. 3-B, FIG. 4-A, and FIG. 4-B), the locating of the entire infrared remote controller 13 at the front end, and a cover C that closes over the infrared remote controller 13 keys and facilitates the grasping of the remote control unit 1 for midair operation and utilization or the cover C provides for manual holding when the mouse 11 is utilized; the keyboard 12 is concealed in the internal portion of the remote control unit 1, one end serving as a pivot joint and the other end having a protruding tab 124 for pulling it out to provide for cordless keyboard operation; the said remote control unit 1 is also equipped with two battery charging contact points 130 at its bottom section for charging batteries when the remote control unit 1 is placed on the charging stand 14 (as shown in FIG. 2-C).

1. A mouse and remote control integration control method and device comprised of:
a. An optical ball having an internally disposed ballast block that situated within the recess of the said mouse, wherein a suspending means enables the center of gravity of the said optical ball to face downward perpendicularly.
b. An optical sensor disposed below the center of gravity of the said optical ball utilized to sense the surface of the said optical ball for control purposes during the midair X- and Y-axis turning of the a control unit, the said optical ball remaining stationary and facing downward due its defined center of gravity, enabling the sensed signal to be fetched by a mouse controller and then outputted via a mouse signal transmitter.
c. A receiver receive module that acquires the said mouse signal, enabling the transfer of the mouse signal through a receive controller and to a personal computer (PC) via a universal serial bus (USB) port such that the said cursor is indicated on a display and execution of various control commands is possible.
d. Left and right keys as well as a scrolling sensor device on the said remote control unit utilized for the remote control of a remote terminal with control signal commands.
e. A switch capable of toggling between an upward facing optical sensor and a downward facing optical sensor to provide for the placement of the said remote control unit on a flat surface and its utilization as a mouse.
As such, by turning the said remote control unit in midair, the said optical sensors sense the surface of the said optical ball and cursor displacement is shown on the display, thereby providing for remote control as well as the on-screen control of networking and other tasks.

2. A mouse and remote control integration control device, the features of which are:
The said remote control unit consists of a mouse, a cordless keyboard, and an infrared remote controller integrated into a single structural entity.
An optical ball is situated the recess of the said mouse and a ballast block is disposed in an optical ball, enabling the said optical ball to face downward perpendicularly because the said ballast block defines its center of gravity, and a suspending means in the said recess supports the said optical ball in position such that when the remote control unit is turned, the said optical ball does not turn along with it due to the said ballast block determining its center of gravity.
An optical sensor is disposed at the lower extent of the said ballast block in the said optical ball that faces upward to sense the surface of the said optical ball.
The said mouse has a scrolling sensor device disposed between its left and right keys or at an appropriate position for functions as well as verifying applications and, at the same time, the said scrolling sensor device control enables the scrolling of the screen.
As such, manually grasping the said remote control unit and turning it in midair, the said ballast block inside the said optical ball utilized to prevent the said optical ball from turning along with it, enabling the said optical sensors and to sense the surface around the said optical ball, thereby providing for the control over cursor displacement on the screen and other operating functions by the said remote control unit in midair.

3. As mentioned in claim 2 of the mouse and remote control integration control device of the invention herein, the said suspending means of the said optical ball consists of a liquid filled into the said recess, liquid buoyancy thereby serving as the suspending means of the said optical ball, with the said ballast block inside at the center of gravity to prevent the turning of the said optical ball.

4. As mentioned in claim 2 of the mouse and remote control integration control device of the invention herein, the said suspending means of the said optical ball consists of a plurality of roller balls disposed in the said recess, thereby limiting the position of the said optical ball and serving as its suspending means in the said recess, with the said ballast block inside the said optical ball inside at the center of gravity to prevent the turning of the said optical ball.

5. As mentioned in claim 2 of the mouse and remote control integration control device of the invention herein, the said keyboard is concealed in the internal portion of the said remote control unit, one end serving as a pivot joint and the other end having a pullable protruding tab that provides for cordless keyboard operation and, furthermore, the said remote control unit is also equipped with two battery charging contact points at its bottom section for charging batteries when the said remote control unit is placed on a charging stand.

6. As mentioned in claim 2 of the mouse and remote control integration control device of the invention herein, the said mouse has an upward facing or a downward facing optical sensor that are toggled by a switch for selecting the sensing position, enabling the selection of mouse operation and control in midair or on a flat surface.
